(19) United States
(12) Patent Application Publication
(10) Pub. No.: US 2005/0281197 A1
(43) Pub. Date: Dec. 22, 2005

(54) Channel control apparatus and channel control method

(76) Inventor: Takashi Honda, Kawasaki (JP)

Correspondence Address: KATTEN MUCHIN ROSENMAN LLP, 575 MADISON AVENUE, NEW YORK, NY, 10022-2585, US

(21) Appl. No.: 10/970,906

(22) Filed: Oct. 22, 2004

(30) Foreign Application Priority Data
Jun. 21, 2004 (JP) 2004-183092

(51) Int. Cl. H04L 12/26

(52) U.S. Cl. 370/235; 370/393

(57) ABSTRACT

A channel control apparatus is arranged in a plurality of nodes on a source as a transmission side and at a node on a sink as a reception side, and changes a bandwidth of virtual concatenation (VC) between the nodes on the source and the sink using link capacity adjustment scheme (LCAS) information. The channel control apparatus includes a VC/LCAS main controller that sets member use-request information for the VC or member usable information for the VC in the LCAS information, and changes the member of the VC between the nodes on the source and the node on the sink.

### CROSS-REFERENCE TO RELATED APPLICATIONS

This application is based upon and claims the benefit of priority from the prior Japanese Patent Application No. 2004-183092, filed on Jun. 21, 2004, the entire contents of which are incorporated herein by reference.

### BACKGROUND OF THE INVENTION

1) Field of the Invention

The present invention relates to a technology for controlling network channels by using information according to link capacity adjustment scheme protocol.

2) Description of the Related Art

There are channel control apparatuses that control network channels. Some of them control channels using information according to the Link Capacity Adjustment Scheme (LCAS) protocol. The LCAS is a protocol used to dynamically change the capacity (bandwidth) of Virtual Concatenation (VC). By dynamically allocating channels using the VC and the LCAS, data for a plurality of protocols (e.g., Gigabit Ethernet™ and ES COM) can be concurrently transmitted to channels based on Synchronous Optical NETwork/Synchronous Digital Hierarchy (SONET/SDH). The channels are regarded as one channel and bandwidths can be dynamically allocated according to the type of data and a required bandwidth, which allows the bandwidths of the channels to be effectively used.

Characteristics of the LCAS include a first function of performing a hitless change (Add and Drop) to a member (transmission channel) of a Virtual Concatenation Group (VCG) if necessary, and a second function of temporarily dropping (Drop) the member from the VCG when a channel failure occurs in the member and again adding (Add) the member to the VCG when the channel failure is recovered.

However, the setting of these channel capacities, and the addition, the dropping, and the change of the capacities are not included in the functions of the LCAS, but executed by a Network and element Management System (NMS).

FIG. 20 is a schematic diagram for explaining the functions of the LCAS. NodeB 201 is provided on a transmission side (source) and NodeA 202 is provided on a reception side (sink). The functions are explained using the case of the NodeB 201 and the NodeA (202). The NodeA 202 includes an interface (I/F) card 203 as an interface for a SONET network provided between the NodeA 202 and the NodeB 201. The NodeA 202 also includes an I/F card 204 as an interface for an Internet Protocol (IP) Packet network. The I/F card 203 includes a VC/LCAS controller 203a. The VC/LCAS controller 203a controls transmission with the NodeB 201 based on the LCAS protocol using a Control Packet (CP) 205.

The CP 205 is used to maintain capacity-change synchronization between the NodeB 201 as the source (So) and the NodeA 202 as the sink (Sk). The CP 205 is set in each pair of nodes that form one path. The CP 205 has the number of members corresponding to the number of members of the VCG in the vertical direction of FIG. 20 (e.g., the number of members=5 as shown in FIG. 20). The CP 205 is used to transmit/receive status information and control information for respective members on the source and the sink of nodes between the nodes. In the LCAS, the CP 205 is used on a unidirectional path basis. It is noted that even when a bidirectional configuration such as 2 way cross connect is to be realized, the same procedure as that of the unidirectional path is performed in the reverse direction.

Fields of the CP 205 are explained below.

1. Forward Direction: The field of the CP 205 from the source (So) to the sink (Sk) includes control information 205a and payload (data to be transmitted and received) 205b. The control information 205a is explained below. Described in the control information 205a of FIG. 20 is only “c. Ctrl” as follows for simplicity.
a. Multi-Frame Indicator (MFI) Field
b. Sequence Indicator (SQ) Field
c. Control (Ctrl) Field
d. Group Identification (GID) Field
e. Cyclic Redundancy Check (CRC) Field (*)
f. Unused bit are reserved and shall be set to “0” (*)

2. Return Direction: The field of the CP 205 from the sink (Sk) to the source (So) includes only control information 205c. Described in the control information 205c of FIG. 20 is only “b. RS-Ack” as follows for simplicity. The processing for LCAS packet is performed on the sink after differential delay is compensated for.
a. Member Status (MST) Field
b. Re-Sequence Acknowledgement (RS-Ack) bit
c. CRC Field (*)
d. Unused bit are reserved and shall be set to “0” (*)

Where * indicates bidirectional.

The fields are explained in detail below.

1-a. MFI: In the So side, this field is common in all the members of the VCG and is increased in each frame. In the Sk side, this field is used to recover payload (data) of the respective members in the group. This field is used to decide differential delay of the VCG.

1-b. SQ: Sequence number is described in this field. The SQ is invalid when the Control Field is Idle. The same sequence number is allocated to the members of the same VCG. However, the SQ of a member that transmits Ctrl=Idle is invalid. In the member that is dropped (deleted) from the VCG, a value larger than the SQ of Ctrl=Eos is set.

1-c. Ctrl: Used to transmit information for So to Sk, and used to perform synchronization and status notification.

FIG. 21 is a diagram representing the definitions of values of Ctrl fields. Set in the Ctrl fields are values corresponding to commands as follows.

Value [0000] and command [Fixed] indicate non-LCAS mode. Value [0001] and command [Add] indicate that a relative member is about to be added to a group. Value [0010] and command [Norm] indicate “Normal transmission”. Value [0011] and command [Eos] indicate “End of Sequence” and normal transmission. Value [0101] and command [Idle] indicate that a relative member is not included in the group or the member is about to be dropped from the group. Value [1111] and command [Dnu] indicate “Do Not Use” (payload is not used), that is, Fail status.

1-d. GID: Used to identify VCG. All the members of an identical VCG have the same value as each other. When the command is Idle, the GID is invalid. By checking GID, it is possible to check, on the sink, that a member of the VCG being received is transmitted from a particular source. Pseudo-random 2ˆ15-1 is used in the contents.

1-e. CRC: Used to simplify checking of a change in Virtual concatenation overhead. In the Sk side, when this is received, CRC checking is performed. If an error has occurred, the data received is not used, but is immediately used if it is normal.

2-a. MST: Status information for all the members of VCG that is transmitted from the Sk side to the So side. The MST includes two statuses that are OK and Fail, and 1 bit is allocated to one member (OK=0, Fail=1). Since MST Field bit is limited in number, it is divided into a plurality of control packets. The Sk side transmits MST together with SQ number received from the So side, to the So side. When Ctrl=Idle is received, MST not used, or channel failure (Fail), MST=Fail is transmitted. When Ctrl=Add, Norm, and Eos are received, MST=OK is transmitted.

2-b. RS-Ack: When a change in the sequence number is detected in the Sk (reception) side, RS-Ack bit is repeatedly transmitted (0→1→0) to the So (transmission) side, and the detection of the change is notified. Upon the notification, the So side starts transmitting MST to be transmitted next. The technology related to the LCAS is disclosed in Japanese Patent Application Laid Open Publication No. 2002-359627.

FIG. 22 is a block diagram of the LCAS based on the conventional technology that is applied to an N:1 network. NodeB (201), NodeC (210), and NodeD (211) are on the source, and NodeA (202) is on the sink.

The NodeA (202) includes a plurality of LCAS controllers 203a which perform communications with the nodes (NodeB, NodeC, and NodeD), respectively. CPs 205 are transmitted and received between the nodes. One of the LCAS controllers 203a includes a reception buffer (memory) 203b and controls the overall data flow. The NodeA (202) receives data transmitted from the nodes (NodeB, NodeC, and NodeD) and transmits the data to NodeE (212). SONET/SDH transmission paths are respectively provided between the corresponding nodes (NodeA to NodeE).

However, the LCAS is configured to be used in point-to-point topology, and therefore, it cannot be applied to a network structure such as N:1.

Assume that the LCAS is used as it is in the network structure such as N:1 as shown in FIG. 22. In the LCAS protocol, the source requests Add or Drop of a member and the sink transmits OK/Fail to realize hitless switch. In this case also, the source determines (requests) the channel to be used, and the channel determined is reserved by the source, so that the sink has no material used to make decision. Therefore, even if reception exceeds the reception capacity of the sink, the sink cannot determine or control any particular member of any particular VCG from which reception should be allowed or stopped, and an overflow may result. In other words, a centralized node (NodeA 202) has to accept the maximum number of VCs, which causes the throughput and the memory capacity of the reception buffer 203b that can receive data to be limited. Consequently, concurrent reception of large amount of data in the network structure results in difficult operation.

As another example, an NMS 220 periodically monitors the reception buffer 203b of the NodeA (202) or data amounts transmitted from the NodeB, NodeC, and NodeD (201, 210, and 211). The NMS 220 determines whether the data amounts increase or decrease and changes setting of the number of VCs over which data is transmitted from the NodeB, NodeC, and NodeD to the NodeA (202).

In this method, the NMS 220 needs to set the nodes (NodeB, NodeC, and NodeD) and to have information for statuses of the members. Therefore, the processing in the NMS 220 becomes complicated, and the data amounts to be held therein increase. In other words, it is required to acquire setting information for all the VCs of the nodes, setting information for all the members, the data amounts to be transmitted and received (collection at each fixed time), and error information for the members. Furthermore, It is required to collect the data amounts to be transmitted and received during a fixed time and to acquire information that dynamically changes such as error information for the members. Therefore, an unnecessary Add or Drop function of a member may be performed depending on data collection timing of each Node. Because of this, it takes time that the control by the LCAS becomes stable. The control for using and stopping of a path by the LCAS is unstable during a period from when a command indicating an increase in a member of the LCAS is received until the member actually increased starts using the VCG.

### SUMMARY OF THE INVENTION

It is an object of the present invention to solve at least the problems in the conventional technology.

A channel control apparatus according to an aspect of the present invention is arranged at a node on a source as a transmission side and at a node on a sink as a reception side, and changes a bandwidth of virtual concatenation using link capacity adjustment scheme information between the node on the source and the node on the sink. The channel control apparatus includes an information adding unit that adds additional information for adjustment of a member of the virtual concatenation, to the link capacity adjustment scheme information; and a virtual concatenation/link capacity adjustment scheme main controller. The virtual concatenation/link capacity adjustment scheme main controller transmits the link capacity adjustment scheme information including the additional information added, to a partner node of either one node on the source and the sink, and adjusts a member of the virtual concatenation based on the additional information added to the link capacity adjustment scheme information, when receiving the link capacity adjustment scheme information including the additional information, from the partner node.

A channel control method according to another aspect of the present invention is a method of changing a bandwidth of virtual concatenation between a node on a source as a transmission side and a node on a sink as a reception side using link capacity adjustment scheme information. The channel control method includes adding additional information for adjustment of a member of the virtual concatenation, to the link capacity adjustment scheme information; transmitting the link capacity adjustment scheme information including the additional information added, to a partner node of either one on the source and the sink; and controlling a member of the virtual concatenation based on the additional information added to the link capacity adjustment scheme information, when receiving the link capacity adjustment scheme information including the additional information, from the partner node.

A channel control method according to another aspect of the present invention is a method of changing a bandwidth of virtual concatenation between a node on a source as a transmission side and a node on a sink as a reception side using link capacity adjustment scheme information. The channel control method includes transmitting the link capacity adjustment scheme information and member use-request information from the node on the source to the node on the sink, the member use-request information indicating whether the node on the source requests to use the virtual concatenation; detecting the amount of data received from the node on the source, at the node on the sink; determining whether to allow reception of data for each member of the virtual concatenation, based on the amount of data received detected at the detecting and the number of members capable of using the virtual concatenation, and obtaining reception propriety information determined; and transmitting the reception propriety information determined as member usable information, to the node on the source, the reception propriety information being included in the link capacity adjustment scheme information.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a configuration of a sink (Sk) in a channel control apparatus of the present invention;

FIG. 2 is a block diagram of a configuration of a source (So) in the channel control apparatus;

FIG. 3A is a diagram of control information for LCAS to be transmitted from the source to the sink in the present invention;

FIG. 3B is a diagram of control information for the LCAS to be transmitted from the sink to the source in the present invention;

FIG. 4A is a diagram of contents of member use-request information included in the control information for the LCAS;

FIG. 4B is a diagram of contents of priority levels included in the control information for the LCAS;

FIG. 4C is a diagram of contents of member usable information included in the control information for the LCAS;

FIG. 5A is a flowchart of channel control on the sink of the channel control apparatus;

FIG. 5B is a flowchart of the channel control on the sink of the channel control apparatus;

FIG. 6 is a block diagram of process for detecting the amount of data received in the channel control apparatus on the sink;

FIG. 7 is a flowchart of channel control on the source of the channel control apparatus;

FIGS. 8 to 13 are schematic diagrams for explaining a channel control status using LCAS information according to the present invention;

FIGS. 14 to 16 are schematic diagrams for explaining how the sink takes the initiative to perform addition of a member by using the LCAS information according to the present invention;

FIGS. 17 to 19 are schematic diagrams for explaining how to change the priority level of the source and to change a member by using the LCAS information according to the present invention;

FIG. 20 is a schematic diagram for explaining functions of the LCAS;

FIG. 21 is a diagram for explaining definitions of values in Ctrl field; and

FIG. 22 is a block diagram of the LCAS based on the conventional technology that is applied to an N:1 network.

### DETAILED DESCRIPTION

Exemplary embodiments of a channel control apparatus and a channel control method according to the present invention are explained in detail below with reference to the accompanying drawings.

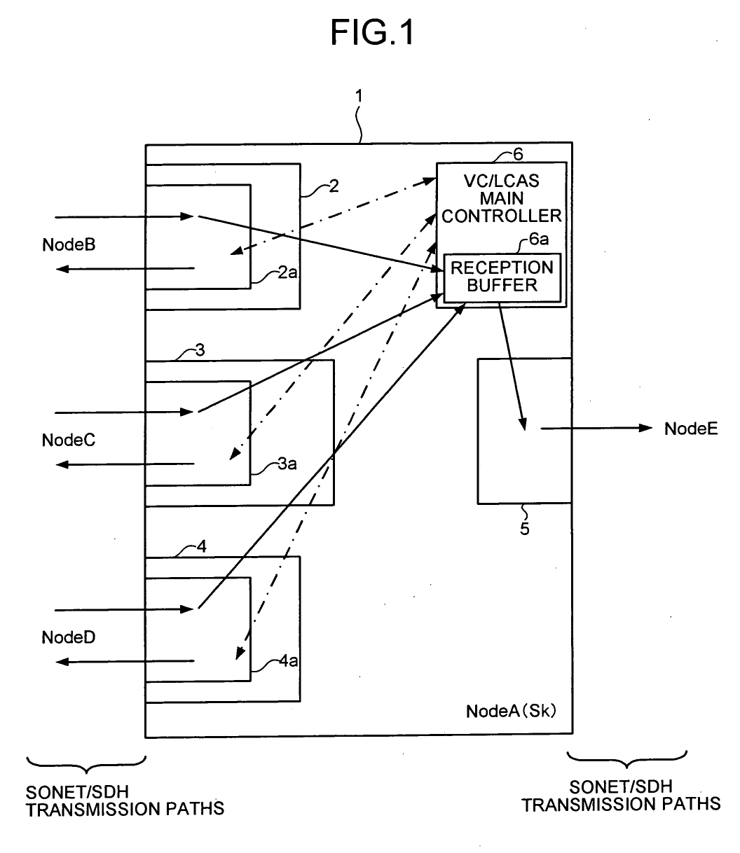

FIG. 1 is a block diagram of a configuration of a sink (Sk) of the channel control apparatus according to the present invention. An example of a channel control apparatus 1 arranged at a node (NodeA) is shown in FIG. 1.

The channel control apparatus 1 includes a plurality of I/F cards 2, 3, and 4 that receive data transmitted from nodes (NodeB, NodeC, and NodeD) on a plurality of sources (So). The I/F cards 2, 3, and 4 include LCAS controllers 2a, 3a, and 4a, respectively. Data received by the I/F cards 2, 3, and 4 is collected in the channel control apparatus 1 and is transmitted to another node (NodeE) through an I/F card 5. Each of nodes (NodeB, NodeC, NodeD, or NodeE) transmits and receives data to and from the channel control apparatus 1 through a transmission path. The transmission paths between the nodes are based on the same transmission scheme (e.g., SONET/SDH) as one another and have the same channel capacity as one another.

The channel control apparatus 1 includes a virtual concatenation/link capacity adjustment scheme main controller (VC/LCAS main controller) 6. The VC/LCAS main controller 6 controls data transmission and reception based on the LCAS with the nodes (NodeB, NodeC, and NodeD) connected thereto through the I/F cards 2, 3, and 4, respectively. The VC/LCAS main controller 6 also controls transmission and reception of the control information for the LCAS. The VC/LCAS main controller 6 includes a reception buffer (memory) 6a that stores data for VCG received by the I/F cards 2, 3, and 4 on the sink. Data flows from the I/F cards 2, 3, and 4 to the I/F card 5 through the reception buffer 6a. The VC/LCAS main controller 6 detects a flow rate of the data received of each VCG and the data amounts of the reception buffer 6a.

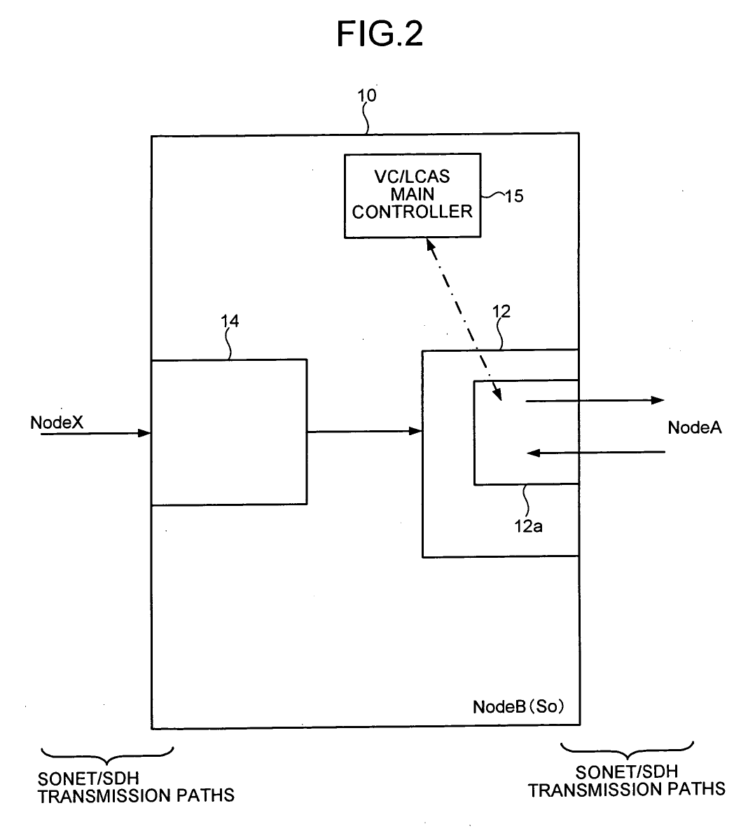

FIG. 2 is a block diagram of a configuration of the source (So) in the channel control apparatus according to the present invention. A channel control apparatus 10 arranged at a node (NodeB) is shown in FIG. 2.

The channel control apparatus 10 includes an I/F card 12 through which data is transmitted to a node (NodeA, FIG. 1) on the sink (Sk). The I/F card 12 includes an LCAS controller 12a. The channel control apparatus 10 receives data transmitted from a node (NodeX) through an I/F card 14, and transmits the data to the node (NodeA) through the I/F card 12.

The channel control apparatus 10 includes a VC/LCAS main controller 15. The VC/LCAS main controller 15 controls data transmission and reception based on the LCAS with the node (NodeA) connected thereto through the I/F card 12. The VC/LCAS main controller 6 also controls transmission and reception of the control information for the LCAS. One channel control apparatus is explained using the different diagrams as shown in FIG. 1 and FIG. 2 in terms of functions of its source and its sink, respectively. Actually, the channel control apparatuses 1 and 10 as shown in FIG. 1 and FIG. 2 are the same as each other. Therefore, the VC/LCAS main controllers 6 and 15 are also the same as each other.

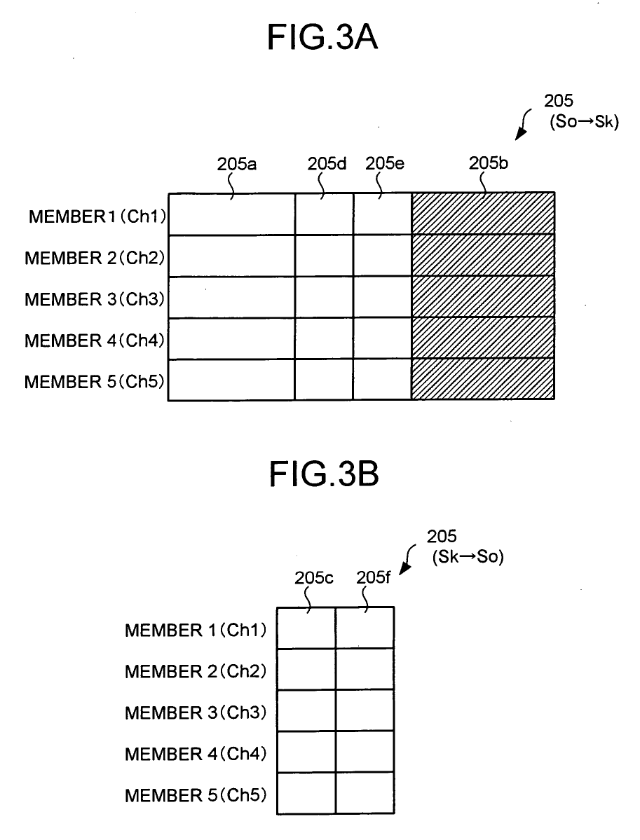

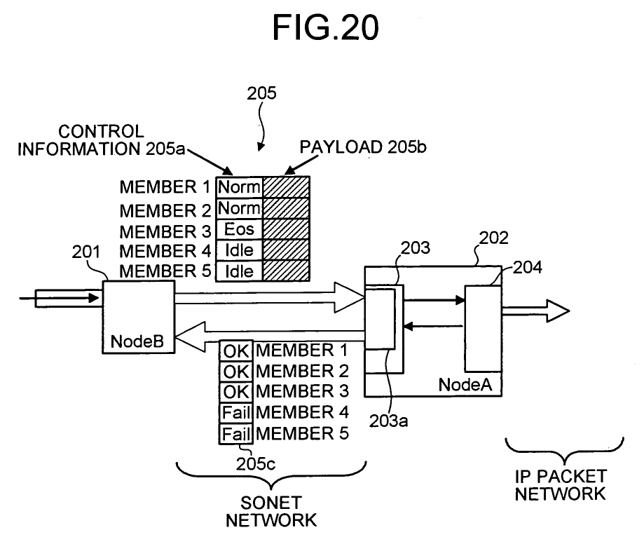

FIG. 3A is a diagram of control information for the LCAS to be transmitted from the source to the sink in the present invention. FIG. 3B is a diagram of control information for the LCAS to be transmitted from the sink to the source in the present invention. As shown in FIG. 3A and FIG. 3B, the same reference signs are assigned to pieces of information the same as these of FIG. 20.

In the VC/LCAS main controller 15, member use-request information 205d and a priority level 205e are provided, for each member (Ch), in CP 205 transmitted from the source to the sink (So→Sk) as shown in FIG. 3A, as additional information to the control information 205a of the CP 205. In the VC/LCAS main controller 6, member usable information 205f is provided, for each member (Ch), in CP 205 transmitted from the sink to the source (Sk→So) as shown in FIG. 3B, as additional information to the control information 205c of the CP 205. These pieces of additional information are added to the control information 205a and 205c of the LCAS by information adding units (not shown) provided in the VC/LCAS main controllers 6 and 15, respectively.

In the following explanation, “Member” and “Ch (Channel)” are synonym. In the present invention, the VC/LCAS main controllers 6 and 15 add the additional information to the control information 205a and 205c for the LCAS, and transmit it to respective partner nodes. For convenience in explanation, the control information 205a, the additional information (the member use-request information 205d, the priority level 205e, and the member usable information 205f) are described as separate fields in these figures.

The VC/LCAS main controllers 6 and 15 (see FIG. 1 and FIG. 2) adjust the amounts of use of members of VC according to transmission and reception of these pieces of control information. The VC/LCAS main controllers 6 and 15 determine whether to add or drop a member to or from VC in nodes which information is transmitted to or received from, based on the additional information and the control information 205a of the existing LCAS, and realize independent response to dynamic changes in VC, although details thereof are explained later. The term “independent” means to response to dynamic changes in VC under no control of the NMS.

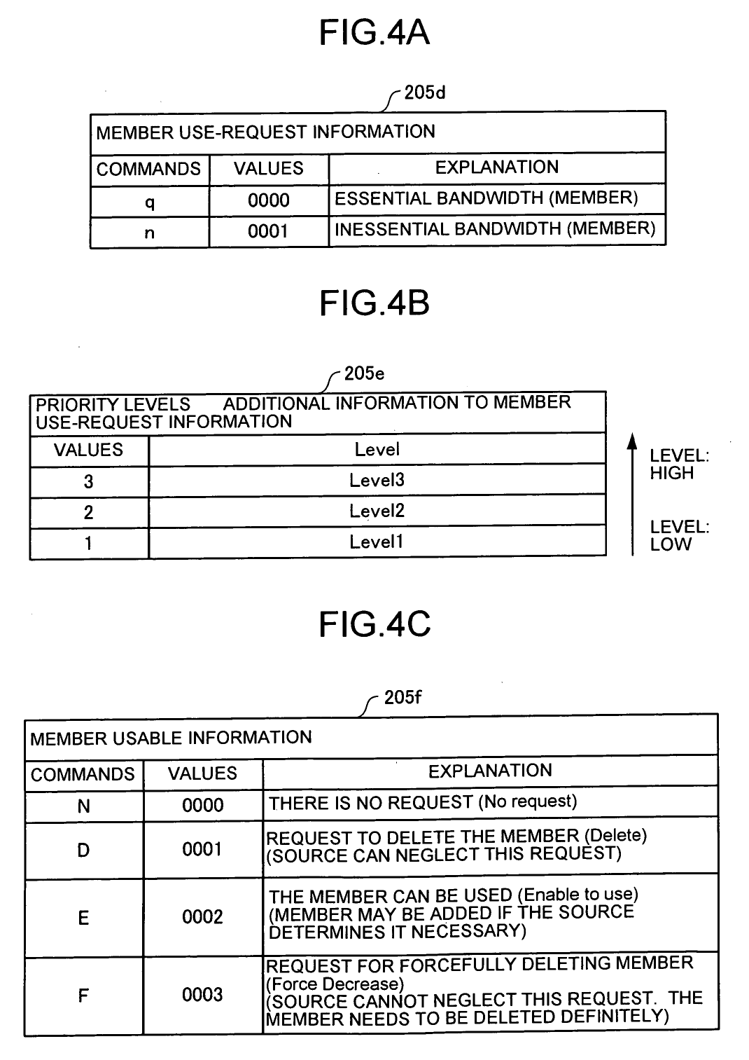

FIG. 4A is a diagram of contents of the member use-request information included in the control information for the LCAS. The member use-request information 205d for each member is included in the control information 205a transmitted from the source to the sink (So→Sk). The member use-request information 205d consists of commands [q, n] and corresponding values [0000, 0001]. The command q (value 0000) indicates that a corresponding member requested to use is an “Essential” bandwidth (member) on the source (So). The “Essential” means that the member is definitely required to use. The command n (value 0001) indicates that a member requested to use is an “Inessential” bandwidth (member). The “Inessential” means that the member is required to use if possible.

FIG. 4B is a diagram of contents of priority levels included in the control information for the LCAS. The priority level 205e is additional information such that a priority level is given to the member use-request information 205d. The priority level 205e consists of values [1, 2, and 3]. A larger value indicates a higher level in the priority levels, and a smaller value indicates a lower level in the priority levels.

FIG. 4C is a diagram of contents of the member usable information included in the control information for the LCAS. The member usable information 205f is included in the control information 205c transmitted from the sink to the source (Sk→So). The member usable information 205f consists of commands [N, D, E, and F] and corresponding values [0000, 0001, 0002, and 0003]. The command N (value 0000) indicates that there is no request from the sink (No request). The command D (value 0001) indicates a request to delete the member (Delete). The command E (value 0002) indicates that the member can be used (Enable to Use). The command F (value 0003) indicates a request to forcefully delete the member (Force Decrease). On the source (So), when the command received is the command D, the command D is negligible. When the command E is required as a result of determination, the member may be added. The command F is not negligible, which means a corresponding member needs to be deleted.

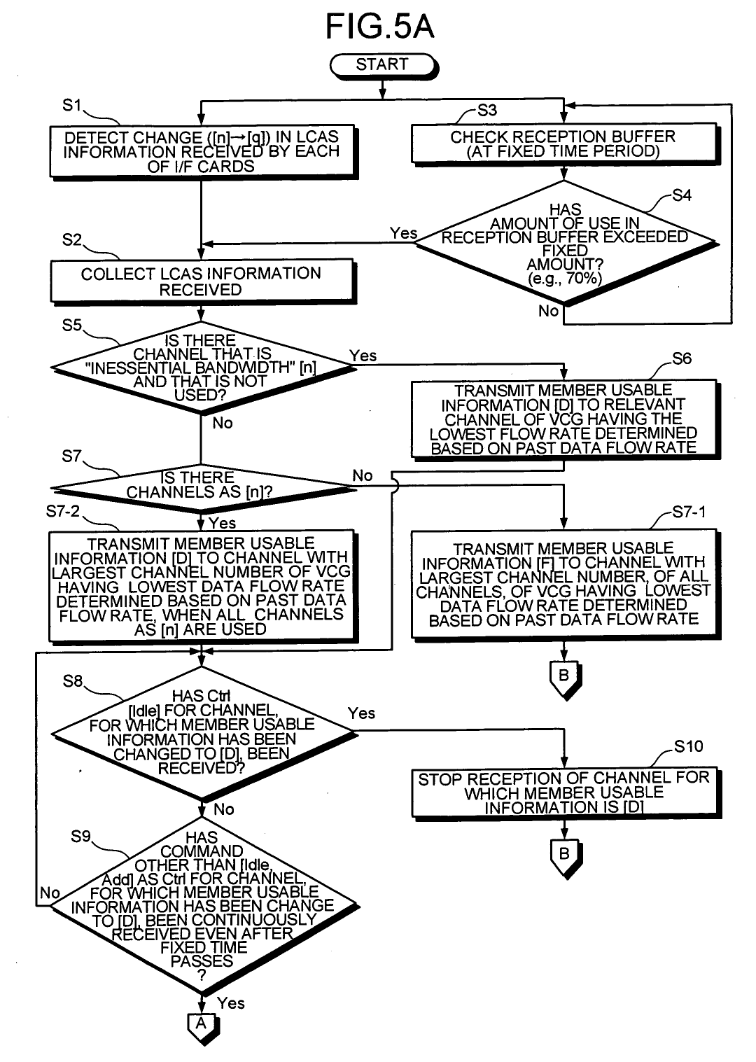

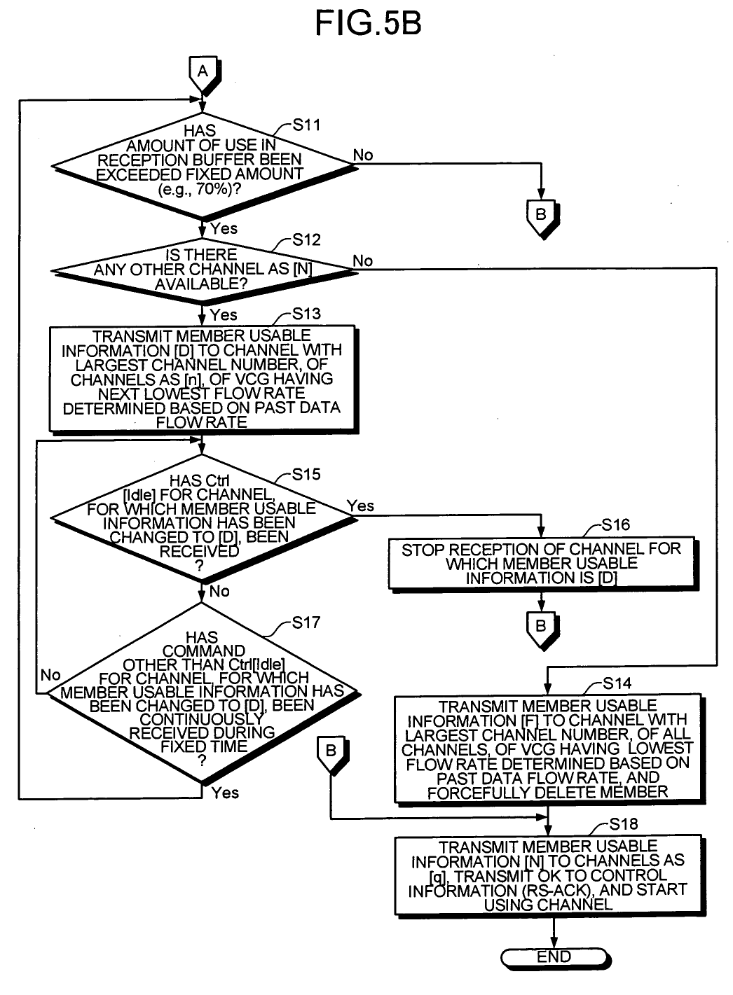

FIG. 5A and FIG. 5B are flowcharts of channel control on the sink of the channel control apparatus. The VC/LCAS main controller 6 provided in the channel control apparatus 1 as shown in FIG. 1 is mainly described.

The sink of the channel control apparatus detects a change in the LCAS information received by each of the I/F cards 2, 3, and 4, from [n] to [q] (step S1). The change indicates that the use-request for a relevant member from the source is changed from “Inessential” to “Essential”. In other words, the change indicates an increase in the essential bandwidth of VCG including the relevant member, which becomes a timing at which the sink adjusts the bandwidth. The sink collects the LCAS information received by each of the I/F cards 2, 3, and 4 (step S2).

The sink of the channel control apparatus checks the amount of use in the reception buffer 6a at a fixed period in parallel to the processing at step S1 (step S3), and determines whether the amount of use in the reception buffer 203b exceeds a preset, fixed amount (e.g., 70%) (step S4). If the amount of use in the reception buffer 6a does not reach the fixed amount (step S4: No), the process returns to step S3, and continues checking at a fixed time period. On the other hand, if the amount of use in the reception buffer 6a exceeds the fixed amount (step S4: Yes), the LCAS information received is collected at step S2. This becomes another timing at which the sink adjusts the bandwidth.

After execution of the processing at step S2, it is determined whether there is any channel of which member use-request information 205d is “Inessential bandwidth” [n] and that is not used (Ctrl field is [Idle]) (step S5). If there is a channel not used (step S5: Yes), the sink transmits the member usable information 205f as Delete [D] to a relevant channel of VCG having the lowest flow rate that is determined based on the past data flow rate (step S6), and the process shifts to step S8 as explained below.

On the other hand, at step S5, it is determined that there is no channel of which member use-request information 205d is Inessential bandwidth [n] and that is not used (step S5: No), and it is determined whether there is a channel as [n] (step S7).

When there is no channel as [n] (step S7: No), the sink transmits the member usable information [F] to a channel of all the channels, and forcefully deletes the member (step S7-1). More specifically, the channel has the largest channel number of VCG having the lowest data flow rate that is determined based on the past data flow rate. The sink transmits the member usable information [N] to a channel for which member use-request information is [q], transmits the OK signal to the control information (RS-Ack), starts using the channel (step S18), and ends the process.

On the other hand, at step S7, when there is a channel as [n], in other words, when all the channels as [n] are used, the sink transmits [D] as the member usable information to a channel (member) of the channels as [n]. More specifically the channel has the largest channel number of VCG having the lowest data flow rate that is determined based on the past data flow rate (step S7-2).

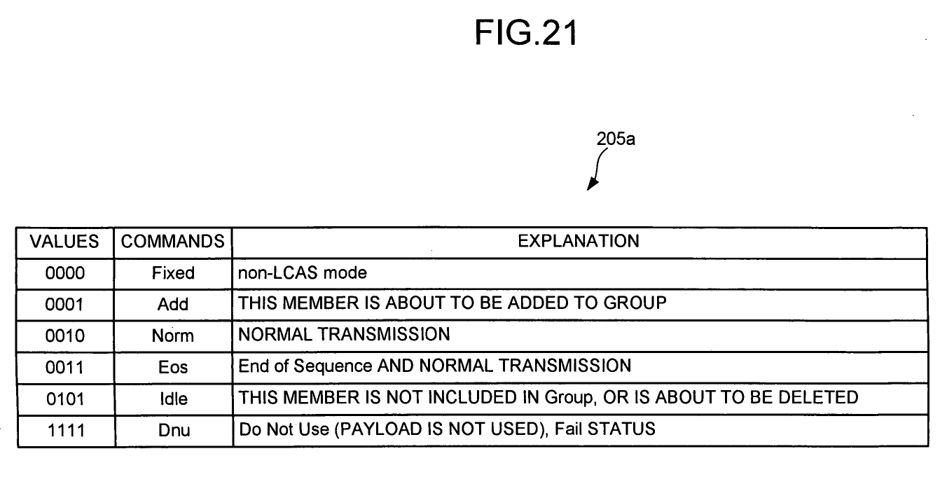

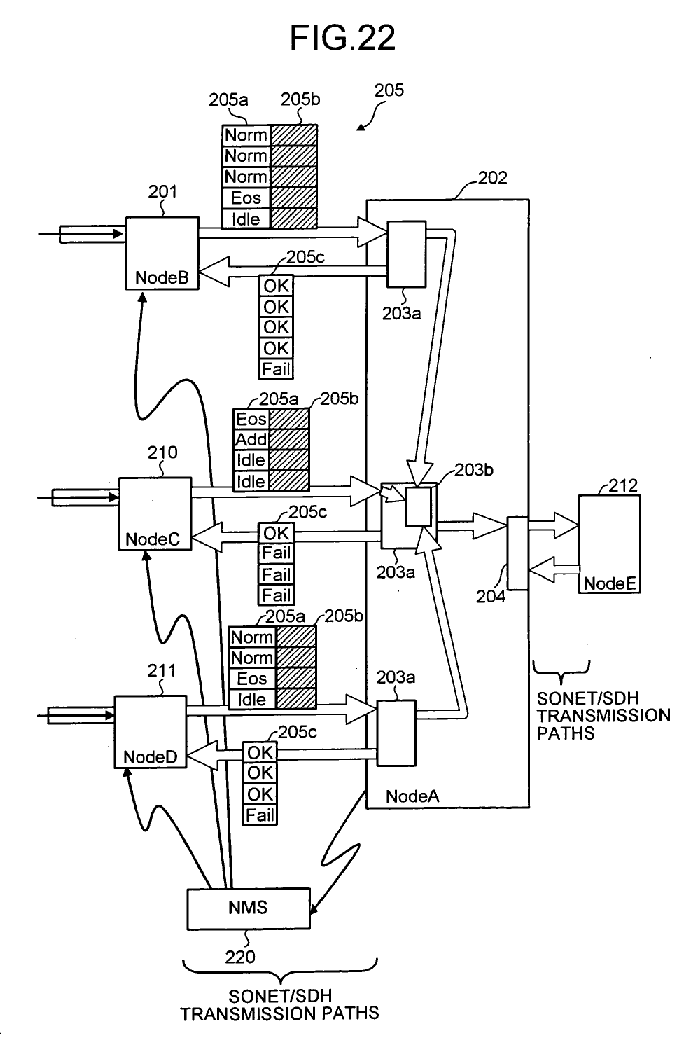

After the processing at step S6 or after the processing at step S7-2, the process shifts to step S8. The sink of the channel control apparatus determines, on the channel for which member usable information 205f has been set to Delete [D], whether Ctrl in the control information 205a received is [Idle] (see FIG. 21) (step S8) . When the Ctrl in the control information 205a received is [Idle] (step S8: Yes), the sink stops reception of the channel for which member usable information 205f is Delete [D] (step S10), transmits the member usable information [N] to a channel for which member use-request information is [q], transmits OK to the control information (RS-Ack), starts using the channel (step S18), and ends the process.

This corresponds to the operations of receiving, from the source, information such that the channel having been requested Delete [D] from the sink is allowed to be deleted. The other operations are reserving a bandwidth by stopping the reception of the corresponding channel, and allocating, if there is a channel as [q], the bandwidth to the channel. On the other hand, when the Ctrl in the control information 205a received is command other than [Idle] (step S8: No), the processing is executed at step S9.

At step S9, the contents of Ctrl in the control information 205a for a channel is monitored for a fixed time. The channel is a target to which Delete [D] has been requested. In other words, it is determined whether any command other than [Idle] as Ctrl in the control information 205a for a channel has been continuously received for a fixed time. The channel is a target to which Delete [D] as the member usable information 205f has been requested.

When the command other than [Idle] as Ctrl in the control information 205a is continuously received for a fixed time (step S9: Yes), the processing is executed at step S11. On the other hand, when the Ctrl in the control information 205a received is [Idle] (step S9: No), the process returns to step S8.

At step S11, it is determined whether the amount of use in the reception buffer 6a exceeds a fixed amount (e.g., 70%). When the amount of use in the reception buffer 6a has exceeded the fixed amount (threshold) (step S11: Yes), the processing is executed at step S12. In this case, the sink transmits [N] as the member usable information indicating “No request”, to the channel to which Delete [D] has been transmitted. On the other hand, when the amount of use in the reception buffer 6a does not reach the fixed amount (step S11: No), the sink ends the process, and transmits the member usable information [N] to the channel for which the member use-request information is changed to [q], transmits OK to the control information (RS-Ack), and starts using the channel (step S18).

At step S9, when the source of a channel that is about to be deleted transmits command other than Ctrl [Idle] i.e., any of Fixed, Add, Norm, and Eos, because the source requests to continuously use the channel (member), [Idle] is not returned. If Dnu is transmitted, [Idle] is not returned because any other trouble may occur and the channel (member) cannot thereby be used. Accordingly, the channel (member) cannot be used. Although the channel (member) cannot be used, the source continuously requests the use thereof or only notifies the sink of the trouble, and therefore, there is no problem as the system. If there is some allowance in the reception buffer 6a, the member is not necessarily deleted. Thus, the channel (member) is made to be added according to the request.

At step S12, it is determined whether there is any other channel for which the member use-request information 205d is [n] as Inessential bandwidth. If the channel is available (step S12: Yes), then the processing is executed at step S13. At step S13, the sink transmits the member usable information 205f as Delete [D] to a channel out of the channels for which the member use-request information 205d is [n] as Inessential bandwidth. More specifically, the channel has the largest channel number of VCG having the next lowest flow rate that is determined based on the past data flow rate.

On the other hand, at step S12, if there is no channel for which the member usable information 205f is [n] as Inessential bandwidth (step S12: No), the processing is executed at step S14. At step S14, the sink transmits the member usable information 205f as Force Decrease [F] (see FIG. 4C) to a channel out of all the channels, and forcefully deletes the member as the channel. More specifically, the channel has the largest channel number of VCG having the lowest flow rate that is determined based on the past data flow rate.

At step S12, if another channel as [n] is available (step S12: Yes), channels as [n] are tried to be sequentially deleted based on the past data flow rate. If deletion is tried on all the channels as [n] (step S13, step S15, and step S17) and if all the tries are unsuccessful, a member as a channel is forcefully deleted at step S14.

After the processing is executed at step S13, it is determined whether [Idle] as Ctrl in the control information 205a for the channel, for which the member usable information 205f has been changed to Delete [D], is received (step S15). If the Ctrl in the control information 205a is [Idle] (step S15: Yes), the sink stops the reception of the channel for which the member usable information 205f has been changed to Delete [D] (step S16), transmits the member usable information [N] to a channel for which the member use-request information is [q], transmits OK to the control information (RS-Ack), starts using the channel (step S18), and ends the process. On the other hand, if the Ctrl in the control information 205a is other than [Idle] (step S15: No), the processing is executed at step S17. At step S17, the contents of Ctrl in the control information 205a for a channel is monitored for a fixed time. The channel is a target to which Delete [D] has been requested. In other words, it is determined whether command other than [Idle] as Ctrl in the control information 205a is continuously received from a channel for a fixed time. The channel is a target to which Delete [D] as the member usable information 205f has been requested.

When command other than [Idle] as Ctrl in the control information 205a is continuously received for a fixed time (step S17: Yes), the process returns to step S11. On the other hand, when the Ctrl in the control information 205a received has been changed to [Idle] within the fixed time (step S17: No), the process returns to step S15.

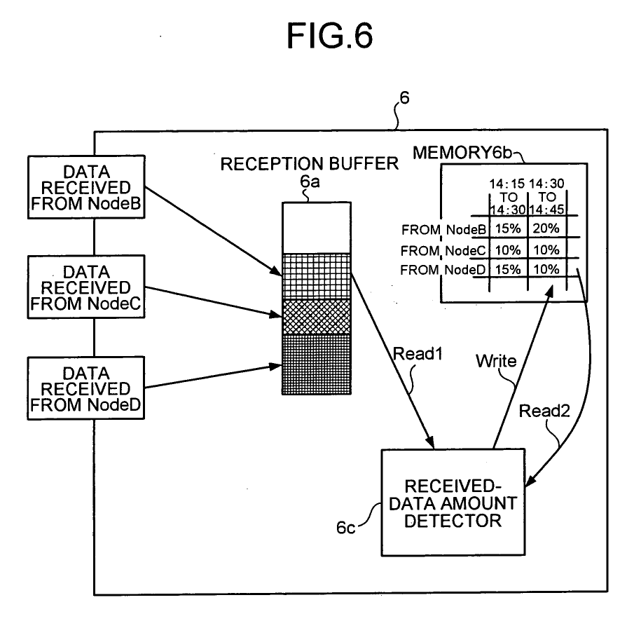

FIG. 6 is a block diagram of process for detecting the amount of data received in the channel control apparatus on the sink. The reception buffer 6a is included in the VC/LCAS main controller 6 in the channel control apparatus 1 of the node (NodeA) on the sink (Sk) (see FIG. 1). The reception buffer 6a stores data for each VCG received from the nodes (NodeB, NodeC, and NodeD) for a fixed time (e.g., 15 minutes or cyclic unit of 1 hour). The VC/LCAS main controller 6A includes a received-data amount detector 6c. The received-data amount detector reads the amount of data received out of the data stored in the reception buffer 6a (Read1), calculates a ratio of data for VCGs time by time transmitted from the nodes (NodeB, NodeC, and NodeD) based on statistical processing, and stores the results of calculation (statistics values). in a storage unit (memory) 6b (Write). The memory 6b stores the results of calculation for a fixed period (e.g., one day or two days).

When the processing for channel control as shown in FIG. 5A and FIG. 5B is to be executed, the received-data amount detector 6c of the VC/LCAS main controller 6 reads the statistics values of the data received in the past that is stored in the memory 6b (Read 2), and uses them for determining whether the VC capacity of each VCG is to be reduced or increased. In the example of FIG. 6, the amounts of data received time by time from the respective nodes (NodeB, NodeC, and NodeD) are stored in the memory 6b, and is referred to as information used to decide the capacity of VC time by time.

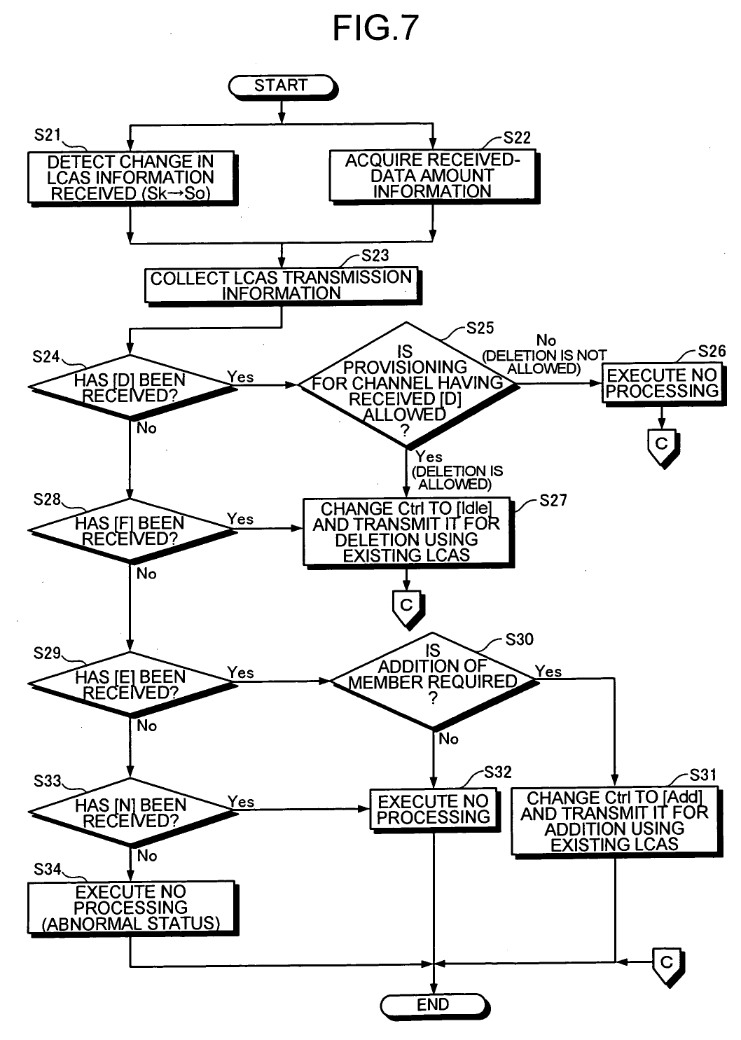

FIG. 7 is a flowchart of channel control on the source of the channel control apparatus. The VC/LCAS main controller 15 provided in the channel control apparatus 10 as shown in FIG. 2 is mainly described with reference to the flowchart.

The source detects a change in LCAS information (Sk→So) received by the I/F card 12 (step S21). At the same time, the source acquires information for the amount of data received (hereinafter, “received-data amount information”) (step S22). The source collects LCAS transmission information to be transmitted by the I/F card 12 based on the change in the LCAS information detected at step S21 and the received-data amount information acquired at step S22 (step S23).

The contents of the member usable information 205f received is determined. It is first determined whether the member usable information 205f is Delete [D] (step S24). If it is Delete [D] (step S24: Yes), it is checked whether provisioning for deletion of the channel that has received Delete [D] is allowed (step S25). As a result, if the channel is not allowed to be deleted (step S25: No), then the source ends the process without performance of any processing on the channel (step S26). On the other hand, if the channel is allowed to be deleted (step S25, Yes), the source deletes the channel using the processing based on the existing LCAS. Therefore, the source sets the control information 205c to [Idle] and transmits [Idle] to the sink (step S27), and ends the process.

At step S24, if the member usable information 205f is command other than Delete [D] (step S24: No), then it is determined whether the member usable information 205f is the request to forcefully delete the member (Force Decrease) [F] (step S28). If it is Force Decrease [F] (step S28: Yes), the processing is executed at step S27. On the other hand, if the member usable information 205f is not Force Decrease [F] (step S28: No), then it is determined whether the member usable information 205f is “Enable to use” [E] such that the member is usable (step S29). If it is Enable to use [E] for the member (step S29: Yes), then it is determined whether addition of the member is required (step S30). It is determined whether the member is to be added based on the amount of data transmitted and received and provisioning for the addition.

If it is determined that addition of the member is required (step S30: Yes), then the source performs addition using the processing for the existing LCAS. Therefore, the source sets the control information 205c to [Add], transmits [Add] (step S31), and ends the process. On the other hand, if it is determined that the addition of the member is not required (step S30: No), then the source performs no processing on the channel (step S32), and ends the process.

At step S29, when the member usable information 205f is not Enable to use [E] for the member (step S29: No), then it is determined whether the member usable information 205f is No request [N] (step S33). If it is No request [N] (step S33: Yes), the processing is executed at step S32, and then the process is ended. On the other hand, if the member usable information 205f is not No request [N] (step S33: No), no processing is executed (step S34) and then the process is ended. In this case, the member usable information 205f does not correspond to any of the preset pieces of information (see FIG. 4C), and therefore, the member usable information 205f is determined abnormal.

A specific example of the processing for the transmission scheme (protocol) using the LCAS information is explained below. In the following explanation, the number of nodes on the source that transmits data to the channel control apparatus 1 (NodeA) is N, and the number of nodes on the sink to which the data is transmitted from the channel control apparatus 1 (NodeA) is 1 (N:1).

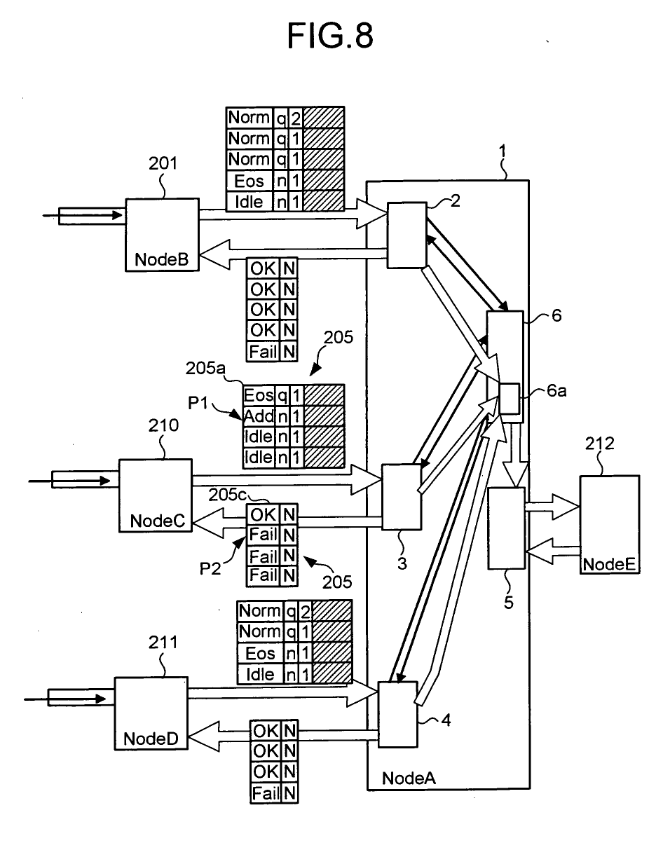

The followings are set as conditions as shown in FIG. 8 to FIG. 19.

1. NodeB→NodeA STS1×5 (Dynamic change is possible by setting the LCAS)

2. NodeC→NodeA STS1×4 (Dynamic change is possible by setting the LCAS)

3. NodeD→NodeA STS1×4 (Dynamic change is possible by setting the LCAS)

4. NodeA→NodeE STS1×2 (Fixed) (not shown) In the examples, the SONET/SDH transmission paths having the same transmission capacity are provided between the nodes (NodeA to NodeE). For example, the setting 1. means that the number of channels (number of members) indicates five STS1 pipes of VC. It is noted that STS1 is abbreviated for Synchronous Transport Signal level 1.

FIG. 8 is a schematic diagram for explaining a channel control status using the LCAS information according to the present invention (Part 1). The status as shown in FIG. 8 indicates that the LCAS is stable. The channel 2 of the NodeC sets Add of the member in the control information (Ctrl) 205a of the CP 205 (P1), and notifies NodeA (channel control apparatus 1) of this setting. The VC/LCAS main controller 6 of the NodeA determines the status of the reception buffer 6a, and sets a status (Fail) indicating no response to Add in the control information 205c of the CP 205 as a result of determination (P2), and continues notifying the NodeC of this setting.

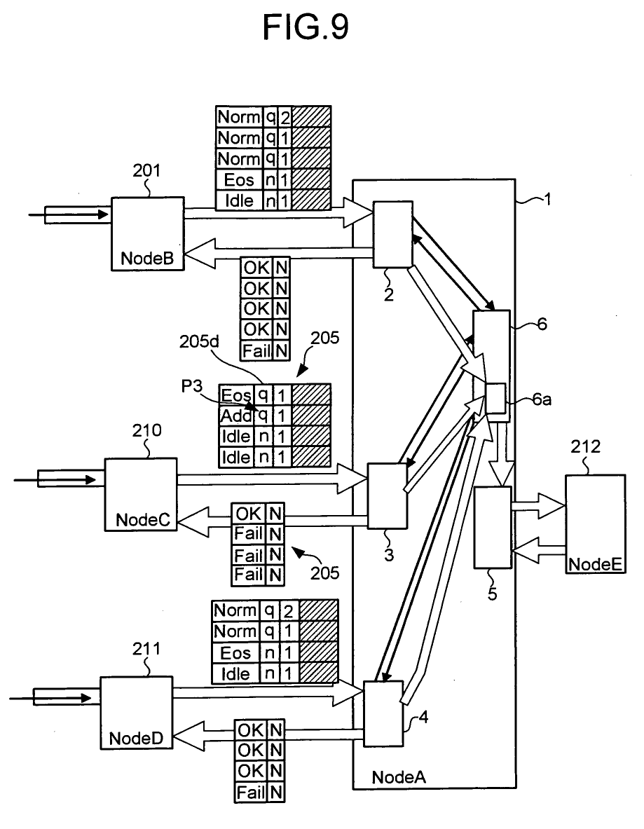

FIG. 9 is a schematic diagram for explaining a channel control status using the LCAS information according to the present invention (Part 2). This status indicates that the member use-request information 205d for VC is changed. That is, after the stable status as shown in FIG. 8, the member use-request information 205d (see FIG. 4A) for the VC is changed when the NodeC transmits the CP 205 to the NodeA. The NodeC changes the member use-request information 205d for the channel 2 from n (“Inessential” bandwidth) to q (“Essential bandwidth”) (P3), and notifies the NodeA of the change.

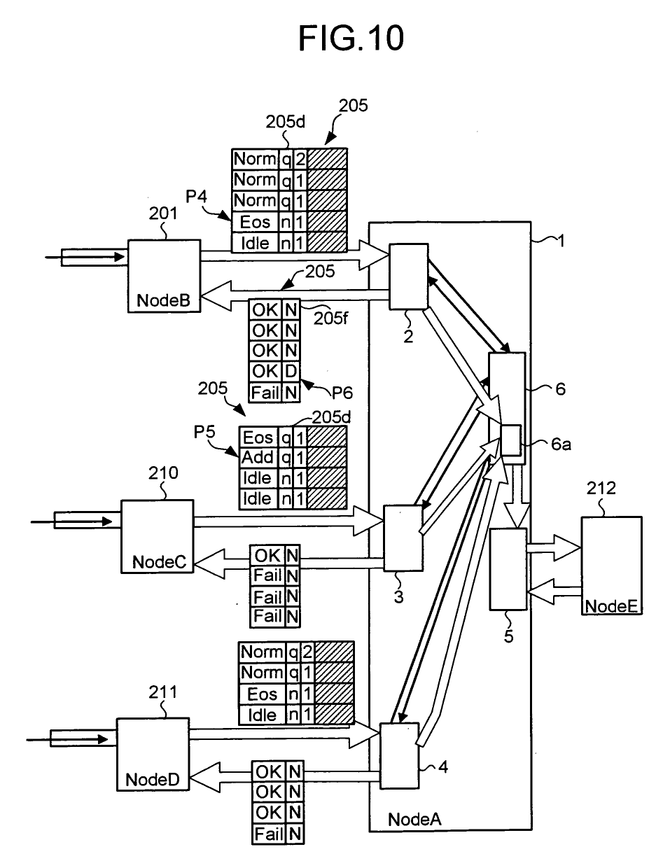

FIG. 10 is a schematic diagram for explaining a channel control status using the LCAS information according to the present invention (Part 3). This status indicates a control status used to allow VC to be used. More specifically, this status indicates how the NodeA controls the CP 205 after the notification of the member use-request information 205d for VC as shown in FIG. 9 is received.

The VC/LCAS main controller 6 of the NodeA (channel control apparatus 1) determines VC that receives data from the nodes (NodeB, NodeC, and NodeD) on the source and the amount of data that can be transmitted to the node (NodeE) on the sink. At this time, the VC/LCAS main controller 6 refers to the member use-request information 205d for the VC notified from a node other than the NodeC. Assume it is detected that the member use-request information 205d for the channel 4 (P4) of the VC notified from the NodeB is n (inessential bandwidth). Assume it is further detected that the member use-request information 205d for the channel 2 (P5) of the VC notified from the NodeC is q (Essential bandwidth).

The VC/LCAS main controller 6 compares the NodeB (channel 4) with the NodeC (channel 2), and determines that the VC of the channel 4 in the NodeB, for which the member use-request information 205d is n (Inessential bandwidth), is made to stop. The VC/LCAS main controller 6 notifies the channel 4 (P6) in the NodeB of the command D (Delete) as the member usable information 205f, and controls so as to cause the VC of the channel 2 between the NodeC and the NodeA to be switched to the status “Enable to us”.

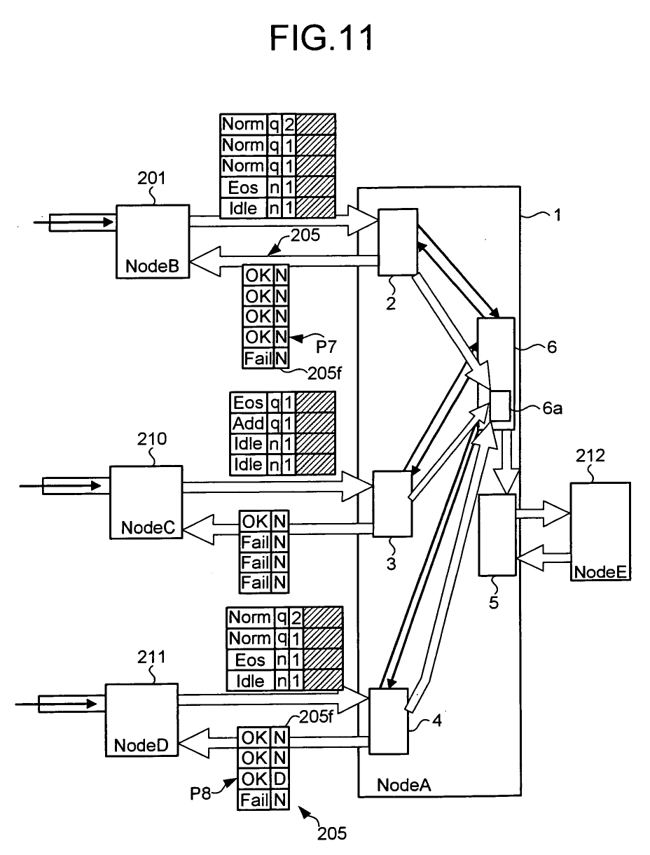

FIG. 11 is a schematic diagram for explaining a channel control status using the LCAS information according to the present invention (Part 4). Assume that after the status as shown in FIG. 10, the channel 4 of the NodeB leaves the control information (Ctrl) 205a (see FIG. 21) for the channel 4 to Eos even after a fixed time passes, and is not stopped to be used (no response). In this case, the VC/LCAS main controller 6 of the NodeA does not perform the process for deleting the channel 4 of the NodeB, and notifies the channel 4 of the command N (No request) as the member usable information 205f for the channel 4 (P7) of the NodeB. After this, the VC/LCAS main controller 6 causes the channel 3 of NodeD to be deleted. The channel 3 of the NodeD has notified the NodeA of Eos according to the control information (Ctrl) 205a. The VC/LCAS main controller 6 notifies the channel 3 of the NodeD (P8) of the command D (Delete) as the member usable information 205f.

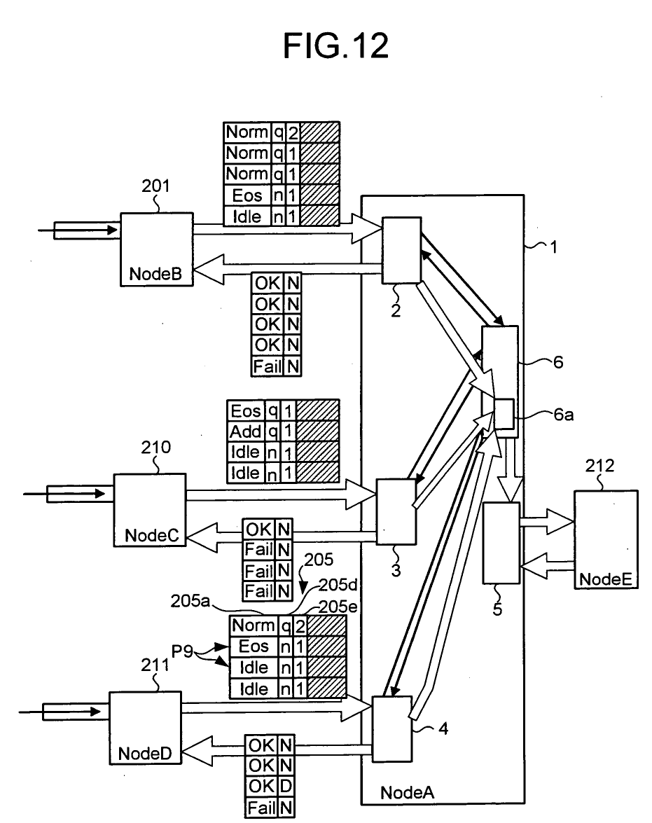

FIG. 12 is a schematic diagram for explaining a channel control status using the LCAS information according to the present invention (Part 5). After the status as shown in FIG. 11, the NodeD stops using (Drop) the VC of the channel 3. At the same time, the NodeD sets the control information (Ctrl) 205a (P9) for the channel 3 to Idle. The NodeD also sets the control information (Ctrl) 205a for the channel 2 to Eos and notifies the NodeA of these statuses.

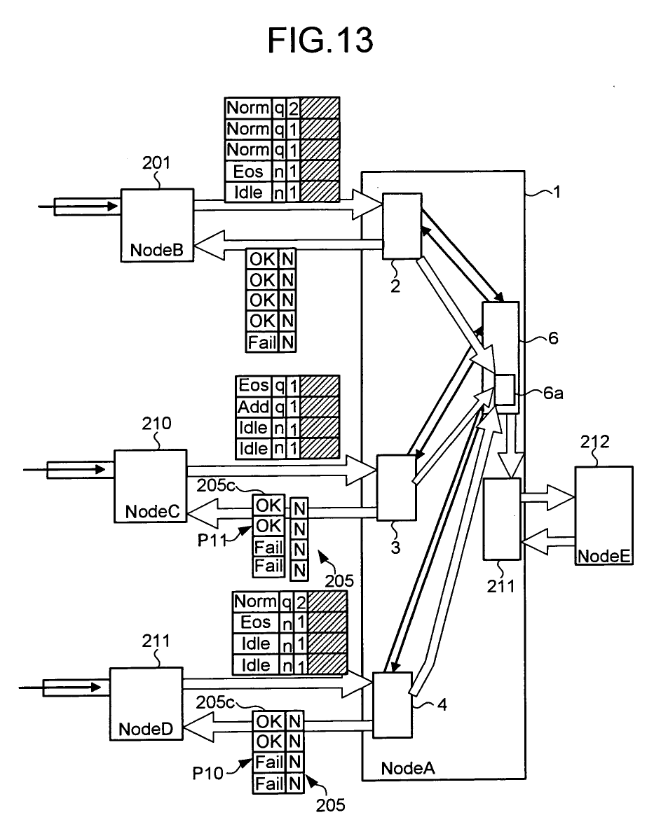

FIG. 13 is a schematic diagram for explaining a channel control status using the LCAS information according to the present invention (Part 6). After the status as shown in FIG. 12, the VC/LCAS main controller 6 of the NodeA sets Fail in the control information 205c (P10) for the channel 3 in the NodeD, and transmits this status to the NodeD. After this, the VC/LCAS main controller 6 sets OK in the control information 205c of the CP 205 for channel 2 (P11) of the NodeC, notifies the NodeC of this status, and starts using the channel 2.

An example in which the node (NodeA) on the sink takes the initiative to change the member usable information 205f (see FIG. 4C) from [N] (No request) to [E] (Enable to use) and adds the member to a corresponding node is explained below. The configuration of the node is the same as that of FIG. 8.

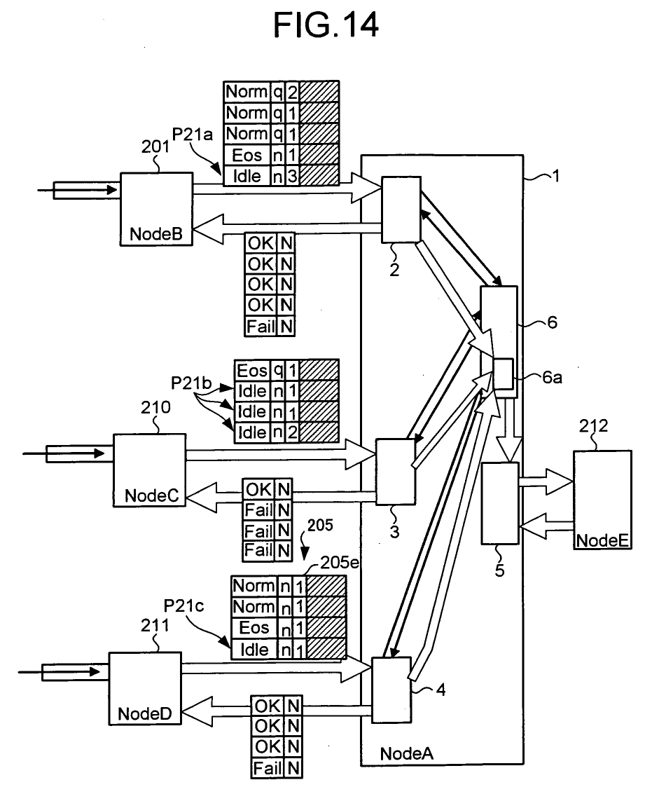

FIG. 14 is a schematic diagram for explaining how the sink takes the initiative to perform addition of a member by using the LCAS information according to the present invention (Part 1). The VC/LCAS main controller 6 of the NodeA (the channel control apparatus 1 on the sink) monitors the amount of data transmitted and received to and from the members. When it is detected that the amount of data transmitted and received falls below a fixed rate during the fixed time, the VC/LCAS main controller 6 of the NodeA determines that a member may be increased in any of the VCGs. The VC/LCAS main controller 6 of the NodeA selects a member that is allowed to be added based on the information for the member, for which the control information (Ctrl) 205a received is [Idle], and the value of the priority level 205e. In the example of FIG. 14, the selectable member includes channel 5 (P21a) of the NodeB, channels 2, 3, and 4 (P21b) of the NodeC, and channel 4 (P21c) of the NodeD because their statuses are [Idle].

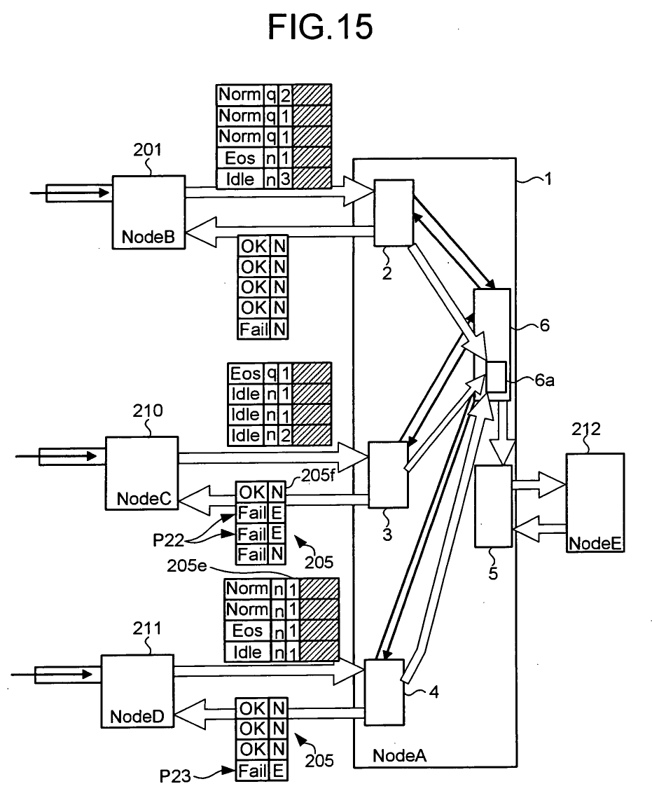

FIG. 15 is a schematic diagram for explaining how the sink takes the initiative to perform addition of a member by using the LCAS information according to the present invention (Part 2). The VC/LCAS main controller 6 changes the member usable information 205f for the member selected to [E] (Enable to use) and notifies the node of the change. At this time, the member of which priority level 205e is [1] is determined that it is allowed to be added. In the example of FIG. 15, the VC/LCAS main controller 6 notifies the channels 2 and 3 (P22) in the NodeC and the channel 4 (P23) in the NodeD of the member usable information 205f [E].

Assume that the amount of data to be transmitted in the NodeD is accumulated and increased. In this case, when receiving the member usable information 205f [E] from the NodeA, the NodeD determines whether the member is to be added based on the accumulated data to be currently transmitted.

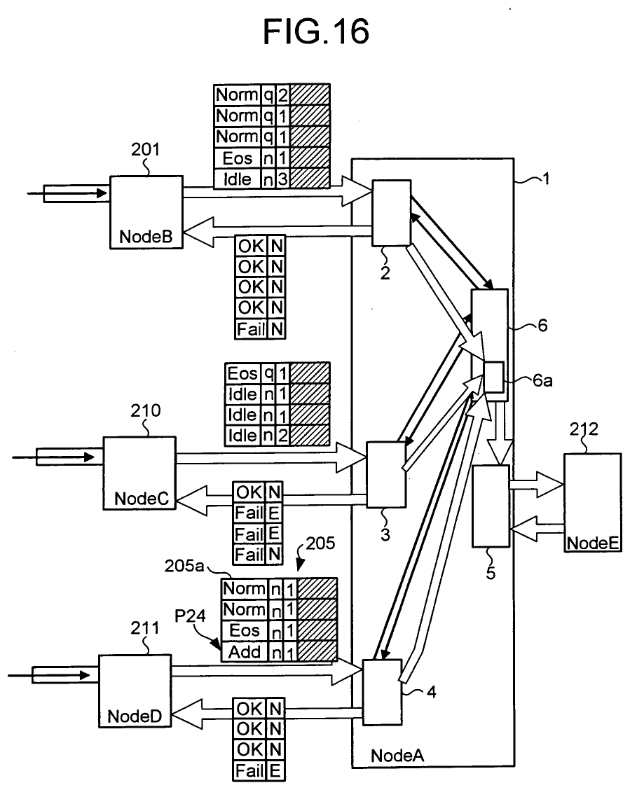

FIG. 16 is a schematic diagram for explaining how the sink takes the initiative to perform addition of a member by using the LCAS information according to the present invention (Part 3). The NodeD changes the control information (Ctrl) 205a for the channel 4 (P24) to Add, and notifies the NodeA of the change. After this, the NodeA transmits and receives the existing LCAS information to and from the NodeD based on Add that has been notified from the NodeD, and adds the member to the NodeD.

An example in which a node (NodeB) on the source changes the priority level 205e (see FIG. 4B) according to the amount of data transmitted and changes the member is explained below. The configuration of the node is the same as that of FIG. 8.

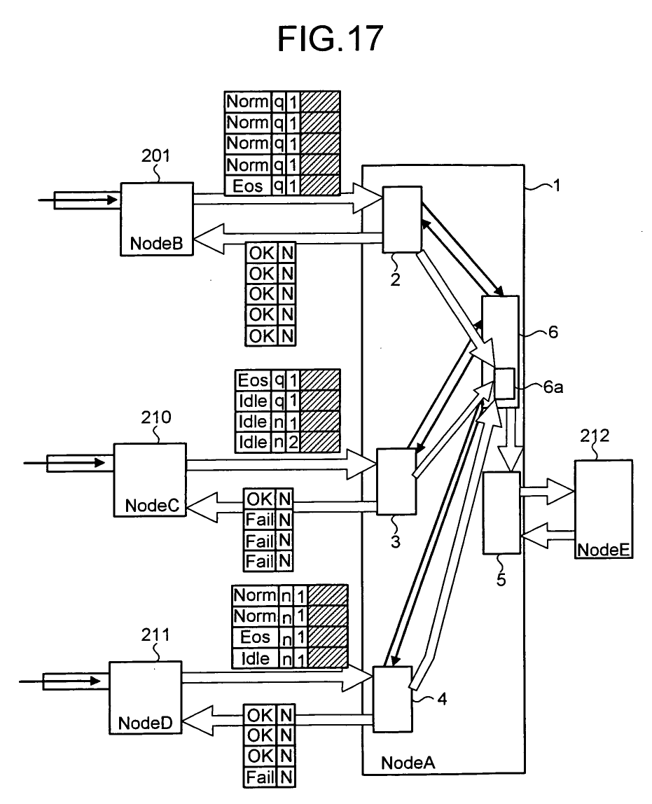

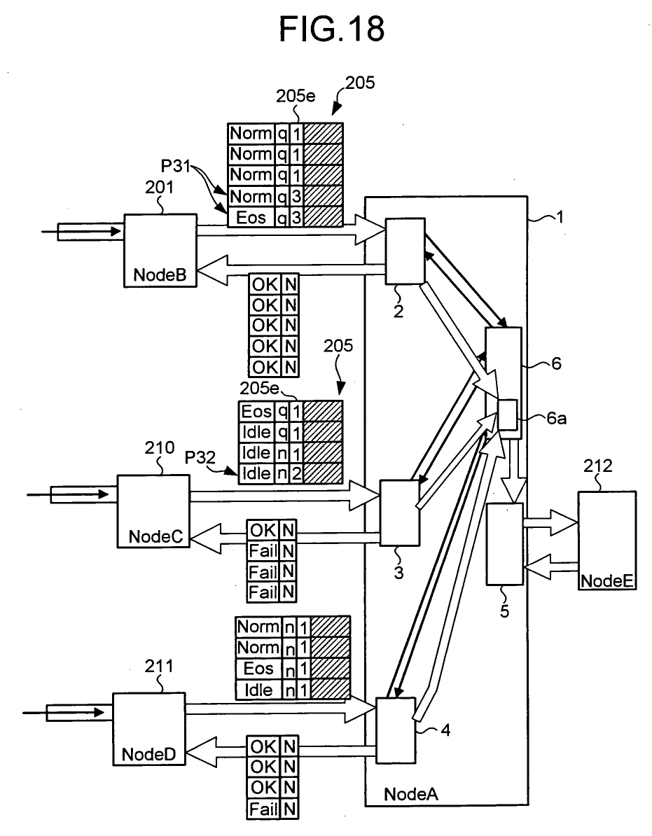

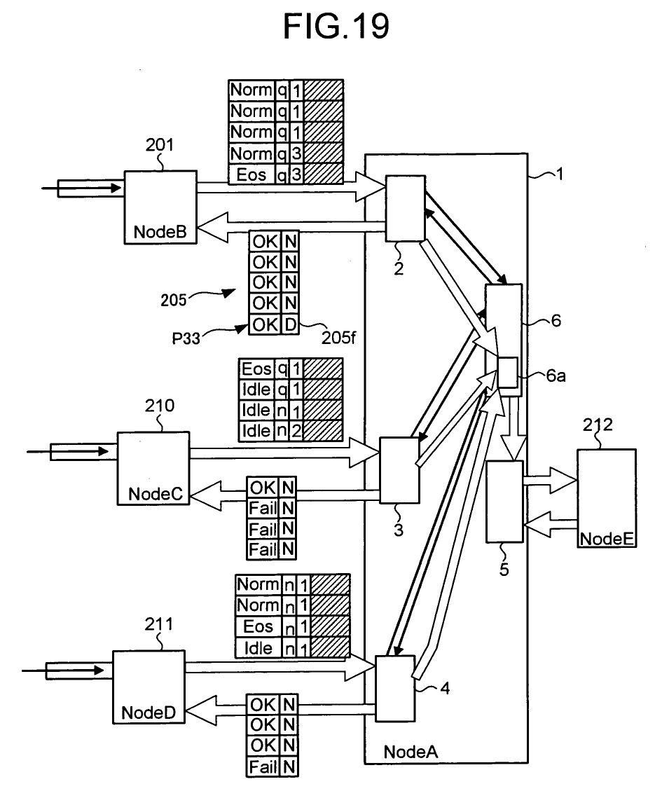

FIG. 17 is a schematic diagram for explaining how to change the priority level of the source and to change a member by using the LCAS information according to the present invention (Part 1). It is noted that FIG. 17 is a basic figure for FIG. 18 and FIG. 19. Assume that data is transmitted and received between nodes in the status as shown in FIG. 17.

FIG. 18 is a schematic diagram for explaining how to change the priority level of the source and to change a member by using the LCAS information according to the present invention (Part 2). Assume that after the status as shown in FIG. 17, the amount of data transmitted in the channels 4 and 5 of the NodeB is decreased. In this case, the NodeB performs the process for lowering the priority level 205e of some of members. The NodeB changes the values of the priority level 205e of the channels 4 and 5 (P31) from [1] to [3]. Assume that the value of the priority level 205e of the channel 4 (P32) in the NodeC is [2] due to the decrease in the amount of data transmitted in the channel 4.

The VC/LCAS main controller 6 of the NodeA determines whether the member is to be added or to be deleted based on the control information 205a received from the nodes. In the example of FIG. 18, the VC/LCAS main controller 6 detects that the member use-request information 205d for the members from the NodeB is [q] (Essential bandwidth) and the values of the priority level 205e of some channels (channels 4 and 5) are [3]. The VC/LCAS main controller 6 further detects that the member use-request information 205d for the member from the NodeC is [n] (Inessential bandwidth) and the value of the priority level 205e of the member is [2].

FIG. 19 is a schematic diagram for explaining how to change the priority level of the source and to change a member by using the LCAS information according to the present invention (Part 3). After the status as shown in FIG. 18, the VC/LCAS main controller 6 of the NodeA decides deletion of the member of channel 5 in the NodeB. The VC/LCAS main controller 6 changes the member usable information 205f for the channel 5 (P33) to the command [D] (Delete), and notifies the NodeB of the change. After this processing, the NodeB transmits and receives the existing LCAS information to and from the NodeA based on [D] notified from the NodeA, and deletes the relative member. The channel made empty through deletion of the member becomes a target to which a new member is added afterward.

According to the present invention, the member use-request information 205d and the member usable information 205f are added to the existing LCAS information. Therefore, even if the network structure is the N:1 network in which the number of nodes on the source is N and the number of nodes on the sink is 1, the node on the sink can adjust so that the VC becomes an appropriate size upon reception of data from a plurality of nodes on the source. In other words, the present invention can realize effective use of channels according to the use frequency of the channels and the importance thereof between nodes. This advantage is different from any conventional device that is operated by the operation from the NMS and uses Fail information at the node on the sink. In the present invention, when the channel of VC to be used is adjusted (Add or Delete), corresponding nodes that transmit and receive data check whether the setting such as the empty capacity of VC or the status thereof is allowed to be changed, and perform processing according to the results of checking. Thus, it is possible to perform adjustment quickly and efficiently after the VC is changed and to reduce the occurrence of flutter during the adjustment.

Furthermore, the node on the source sets the required amount of capacity to be used independently from the maximum capacity of VC using the member use-request information 205d, and transmits the amount set to a device the sink. Therefore, in the N:1 network, a node on the sink can adequately execute adjustment such as using or stopping a member of VC even if the node on the sink receives a large amount of data or the transmission capability of the node is low. As a result, even if reception of a node on the sink exceeds the reception capability thereof, the node on the sink can adequately determine whether to receive or stop data from any particular member of any particular channel. Thus, the overflow of data received can be prevented beforehand.

The VC/LCAS main controller 6 provided at the node on the sink obtains information for the amount of data to be actually transmitted and information for the amount of data received in the past, and can set whether to allow reception in the member usable information 205f based on the pieces of information. As a result, it is possible to prevent the overflow of data caused by concurrently receiving a large amount of data from a plurality of nodes.

The node on the source can also drop a channel of VC based on the information, as to whether to receive data, set in the member usable information 205f that is added to the LCAS information for the node on the sink. This Drop function is performed when another network path for transmission is available, when preferential transmission is not required, or when transmission needs to be continued. Alternatively, if no other network path is available, the channel of VC can be continuously used as it is. In this manner, the node on the source not only changes the size of the VC but makes effective use of another network and determines whether data is to be transmitted.

As explained above, the present invention is configured to add the member use-request information 205d, the priority level 205e, and the member usable information 205f, as additional information, to the LCAS information and to transmit the additional information to a partner node. The additional information is extended for the existing LCAS information, and therefore, it is negligible in any node that handles only the existing LCAS information.

In the node on the sink, when data for another channel is fully received and some channel is not used, and when data transmission is started over the channel that has not been used, the data from this channel needs to be received. The node on the sink sets a plurality of levels as to whether to allow reception, in the member usable information 205f that is notified to the source, which allows the use assignment of channels to be changed according to the setting.

As explained above, in the channel control apparatus and the channel control method of the present invention, even if the number of nodes on the source and on the sink is N:1, the size of VC to be used can be adequately adjusted. Furthermore, the nodes on the source and on the sink can independently decide the information for use of channels and the information for channels to be increased or decreased under no control of the NMS, which does not cause the NMS to add the processing load.

The channel control method explained with reference to the embodiment can be realized by allowing a computer such as a personal computer or a work station to execute a pre-prepared program. The program is recorded in a computer-readable recording medium such as a hard disk, a flexible disk, a compact disk-read only memory (CD-ROM), a magnet-optical (MO) disk, and a digital versatile disk (DVD), and is executed by being read from the recording medium by the computer. Furthermore, the program may be a transmission medium capable of being distributed through a network such as the Internet.

According to the channel control apparatus and the channel control method of the present invention, it is advantageous that effective use of channels can be realized according to the use frequency of the channels and the importance thereof between nodes. Particularly, even if a network is the N:1 network in which the number of nodes on the source is N and the number of nodes on the sink is 1, the node on the sink can smoothly realize size adjustment of VC using the LCAS information under no control of the NMS. Therefore, it is possible to make effective use of channels according to the use frequency of the channels and the importance thereof.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A channel control apparatus that is arranged at a node on a source as a transmission side and at a node on a sink as a reception side, and changes a bandwidth of virtual concatenation using link capacity adjustment scheme information between the node on the source and the node on the sink, the channel control apparatus comprising:
an information adding unit that adds additional information for adjustment of a member of the virtual concatenation, to the link capacity adjustment scheme information; and
a virtual concatenation/link capacity adjustment scheme main controller that
transmits the link capacity adjustment scheme information including the additional information added, to a partner node of either one node on the source and the sink, and
adjusts a member of the virtual concatenation based on the additional information added to the link capacity adjustment scheme information, when receiving the link capacity adjustment scheme information including the additional information, from the partner node.

2. The channel control apparatus according to claim 1, wherein
the information adding unit at the node on the source uses member use-request information as one of the additional information to include information in the member use-request information, the information being as to whether the node on the source requests to use the virtual concatenation.

3. The channel control apparatus according to claim 2, wherein
the information adding unit at the node on the source uses the member use-request information as one of the additional information and uses priority level information for the member use-request information to include a priority level in the priority level information, the priority level being used when the member uses the virtual concatenation at the node on the source.

4. The channel control apparatus according to claim 1, wherein
the virtual concatenation/link capacity adjustment scheme main controller at the node on the sink includes
a received-data amount detector that detects the amount of data received from the node on the source, and
determines whether to allow reception of data for each member of the virtual concatenation, based on the amount of data received detected by the received-data amount detector and the number of members capable of using the virtual concatenation, and
the information adding unit uses member usable information as one of the additional information to include information in the member usable information, the information being as to whether to allow use of each member of the virtual concatenation,

5. The channel control apparatus according to claim 4, wherein
the received-data amount detector stores statistics values in a storage unit, the statistics values being obtained by subjecting the amount of data received in the past to statistical processing, and
the virtual concatenation/link capacity adjustment scheme main controller refers to the statistics values of the data received in the past stored in the storage unit, and determines whether to allow reception of data for each of the members.

6. The channel control apparatus according to claim 4, wherein
the virtual concatenation/link capacity adjustment scheme main controller provided at the node on the sink determines whether to allow use of the member, or determines a request for the level of deletion using a plurality of levels that is included in the member usable information.

7. The channel control apparatus according to claim 4, wherein
the virtual concatenation/link capacity adjustment scheme main controller at the node on the source executes a change of the member, based on the information as to whether to allow reception of data included in the member usable information transmitted from the node on the sink.

8. The channel control apparatus according to claim 1, wherein the channel control apparatus is provided in each node of an N:1 network in which the number of nodes on the source is N and the number of nodes on the sink is 1.

9. A channel control method of changing a bandwidth of virtual concatenation between a node on a source as a transmission side and a node on a sink as a reception side using link capacity adjustment scheme information, the channel control method comprising:
adding additional information for adjustment of a member of the virtual concatenation, to the link capacity adjustment scheme information;
transmitting the link capacity adjustment scheme information including the additional information added, to a partner node of either one on the source and the sink; and
controlling a member of the virtual concatenation based on the additional information added to the link capacity adjustment scheme information, when receiving the link capacity adjustment scheme information including the additional information, from the partner node.

10. A channel control method of changing a bandwidth of virtual concatenation between a node on a source as a transmission side and a node on a sink as a reception side using link capacity adjustment scheme information, the channel control method comprising:
transmitting the link capacity adjustment scheme information and member use-request information from the node on the source to the node on the sink, the member use-request information indicating whether the node on the source requests to use the virtual concatenation;
detecting the amount of data received from the node on the source, at the node on the sink;
determining whether to allow reception of data for each member of the virtual concatenation, based on the amount of data received detected at the detecting and the number of members capable of using the virtual concatenation, and obtaining reception propriety information determined; and
transmitting the reception propriety information determined as member usable information, to the node on the source, the reception propriety information being included in the link capacity adjustment scheme information.

11. The channel control method according to claim 10, wherein
the transmitting link capacity adjustment scheme information includes
transmitting priority level information together with the member use-request information to the node on the sink, the priority level information indicating contents of a priority level at which the member at the node on the source uses the virtual concatenation, and being included in the link capacity adjustment scheme information.

12. The channel control method according to claim 10, wherein at the node on the source performing
adjusting a member that uses the virtual concatenation based on contents of the reception propriety information indicated by the member usable information transmitted from the node on the sink.

13. The channel control method according to claim 11, wherein at the node on the source performing
adjusting a member that uses the virtual concatenation based on the member usable information transmitted from the node on the sink and the priority level information.
